(19) United States
(12) Patent Application Publication
(10) Pub. No.: US 2013/0306497 A1
(43) Pub. Date: Nov. 21, 2013

(54) PAINT CONTAINER WITH A RELEASABLY SECURED LINER

(71) Applicants: Timothy James Llewellyn, Ealing (GB); Eric Thomas Connolly, Wiltshire (GB)

(72) Inventors: Timothy James Llewellyn, Ealing (GB); Eric Thomas Connolly, Wiltshire (GB)

(73) Assignee: AKZO NOBEL COATINGS INTERNATIONAL B.V., Arnhem (NL)

(21) Appl. No.: 13/982,873

(22) PCT Filed: Feb. 7, 2012
(86) PCT No.: PCT/EP2012/000550

§ 371 Date: Jul. 31, 2013

(30) Foreign Application Priority Data
Feb. 7, 2011 (GB) GB 1102039.3

(51) Int. Cl. B44D 3/12

(52) U.S. Cl. CPC B44D 3/12
USPC 206/1.7

(57) ABSTRACT

A paint container (10) including a main body (12), a liner assembly (18) which locates inside the main body, and a shroud (14), in which the shroud cooperates with the liner assembly and the main body so as to releasably secure the liner assembly to the main body.

The present invention relates to a paint container, specifically to a paint container where some of the components can be recycled and/or reused.

Typically, paint containers comprise a main body (cylindrical or rectangular cross section) made from metal, or plastic, and the paint contained therein is in direct contact with the main body. Recycling or re-use of the paint container is made difficult because the main body has been contaminated with paint.

This can be overcome by the use of a plastic liner which locates inside the main body, and receives the paint, thereby preventing contact between the main body and the paint. The contaminated liner is disposed of after use, and the main body can be re-used/recycled.

The problem with known paint containers comprising liners is the security of the liner itself within the paint container.

An object of the present invention is to provide a paint container that incorporates a liner that is more secure.

According to the present invention there is provided a paint container including a main body, a liner assembly which locates inside the main body, and a shroud, in which the shroud cooperates with the liner assembly and the main body so as to releasably secure the liner assembly to the main body.

Advantageously, the liner can be releasably secured to the main body, and the provision of both a liner assembly and a shroud, i.e. two separate components, enables easier plastic moulding when compared to a one-piece construction.

Preferably the liner assembly is releasably attachable to the shroud which enables the non-contaminated shroud to be recycled/re-used, and the contaminated liner assembly to be disposed of, thereby decreasing the amount of material to be disposed of.

The invention will now be described with reference to the accompany drawings, in which:

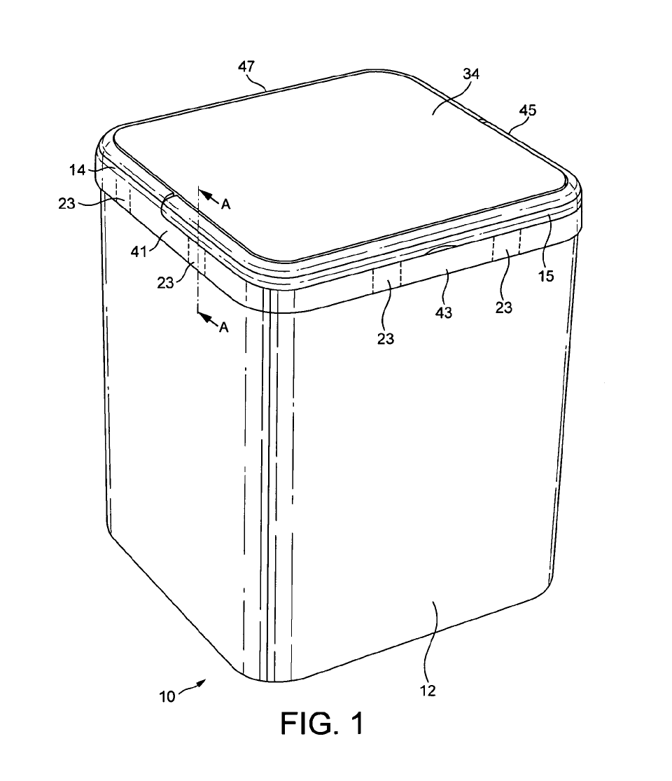

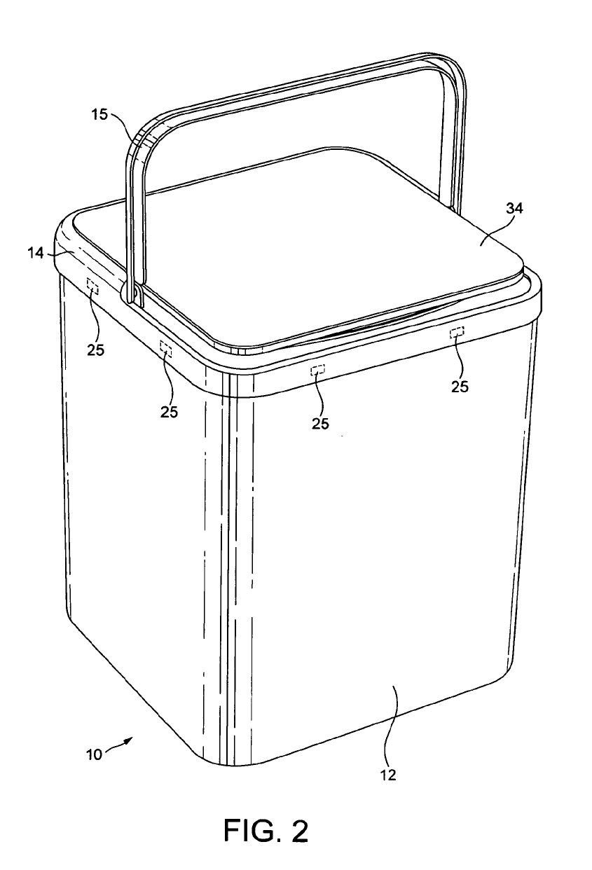

FIGS. 1 and 2 are perspective views of a paint container according to the present invention,

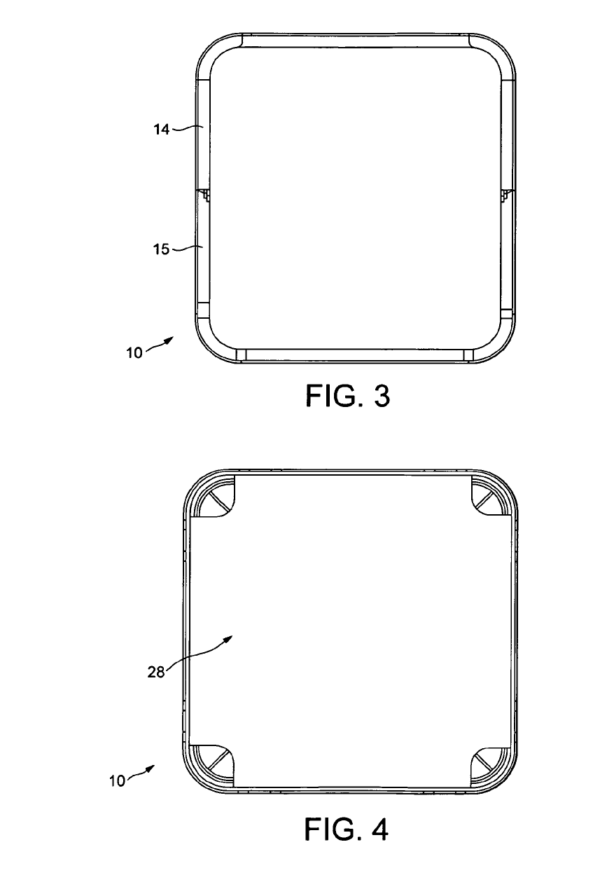

FIG. 3 is a top plan view of the paint container of FIG. 1,

FIG. 4 is a bottom plan view of the paint container of FIG. 1,

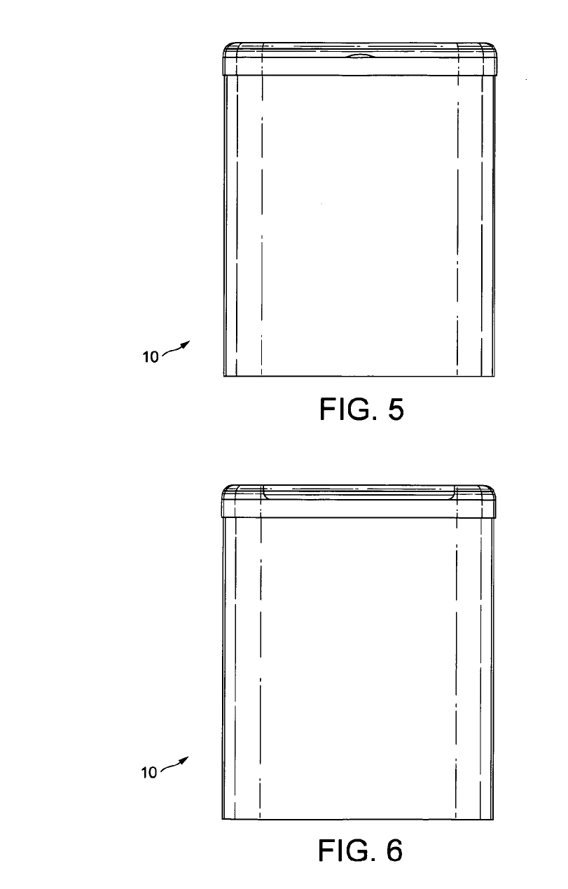

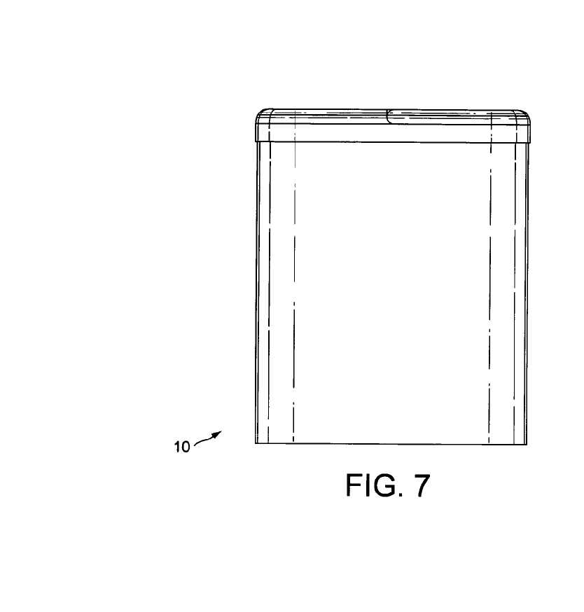

FIGS. 5 to 7 are side views of the paint container of FIG. 1,

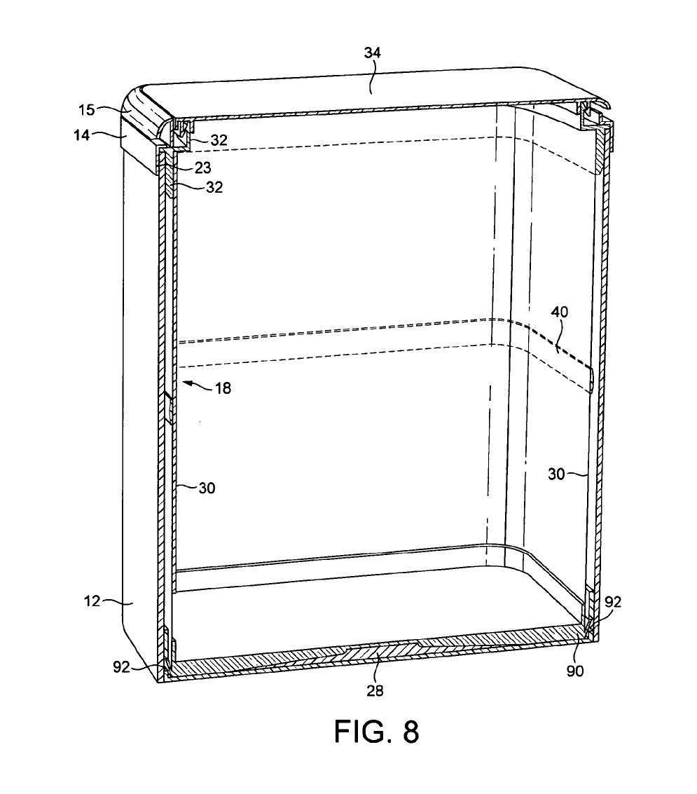

FIG. 8 is a sectional (A-A) perspective view of the paint container of FIG. 1,

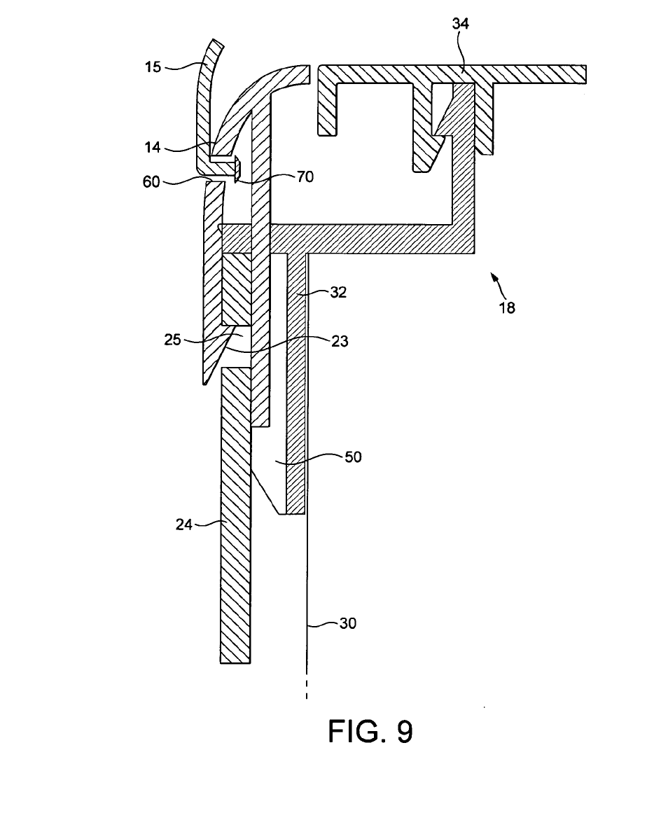

FIG. 9 is a sectional (A-A) side view of the view of the paint container of FIG. 1,

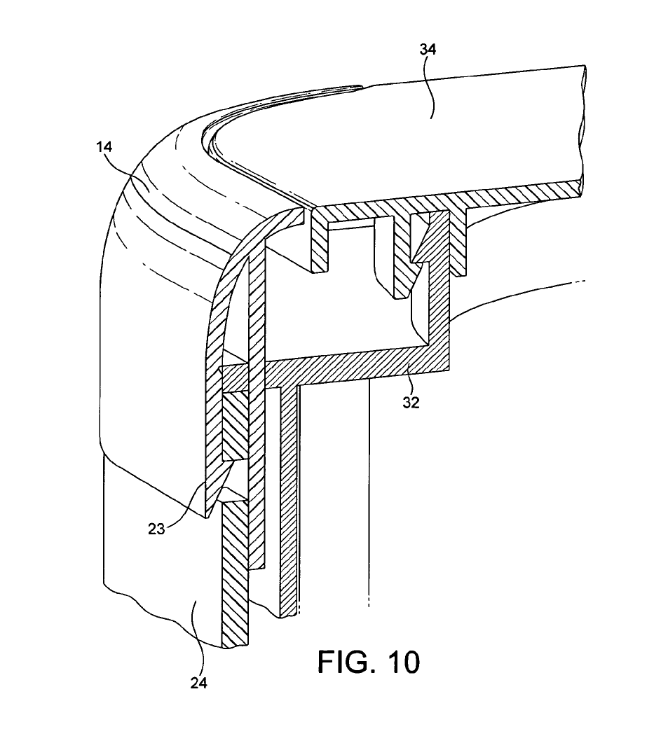

FIG. 10 is a sectional (A-A) perspective view of the paint container of FIG. 1,

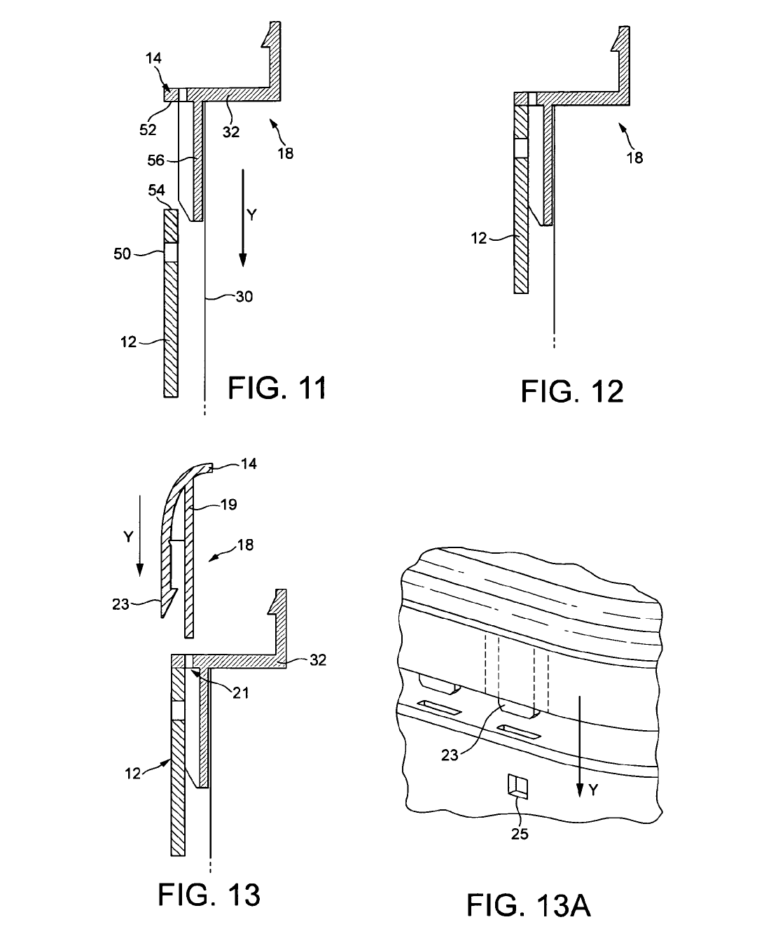

FIGS. 11 to 17 are sectional (A-A) side views and perspective views showing assembly of the paint container of FIG. 1,

FIG. 18 is a sectional (A-A) side view showing part of the paint container of FIG. 1,

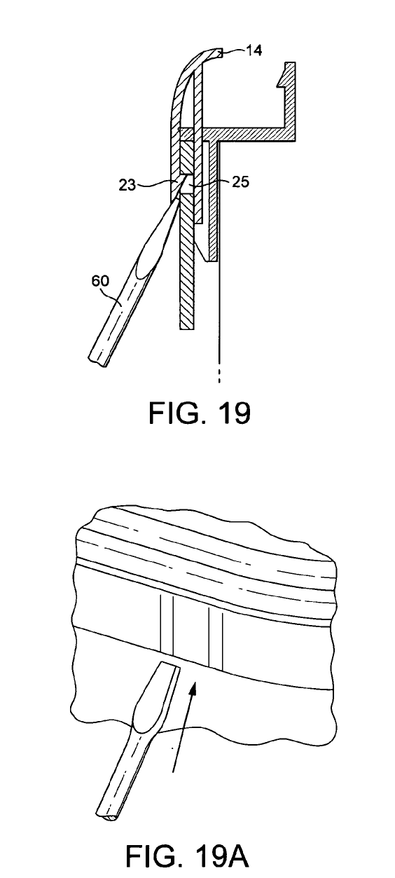

FIGS. 19 to 22 are sectional (A-A) side views and perspective views showing disassembly of the paint container of FIG. 1,

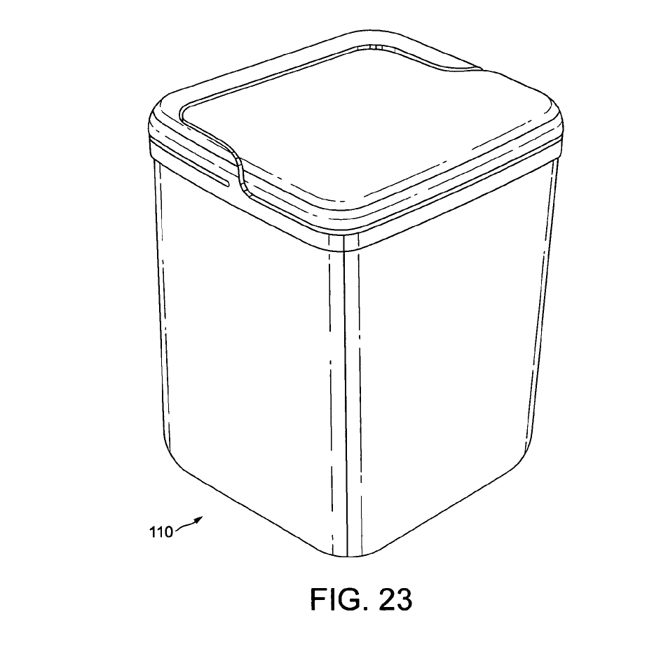

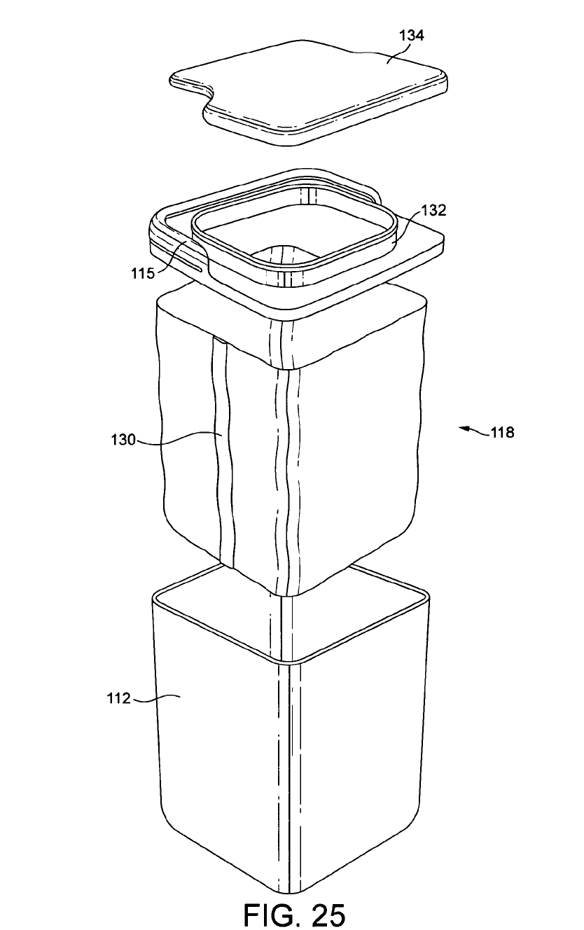

FIGS. 23 to 25 are perspective views of an alternative paint container,

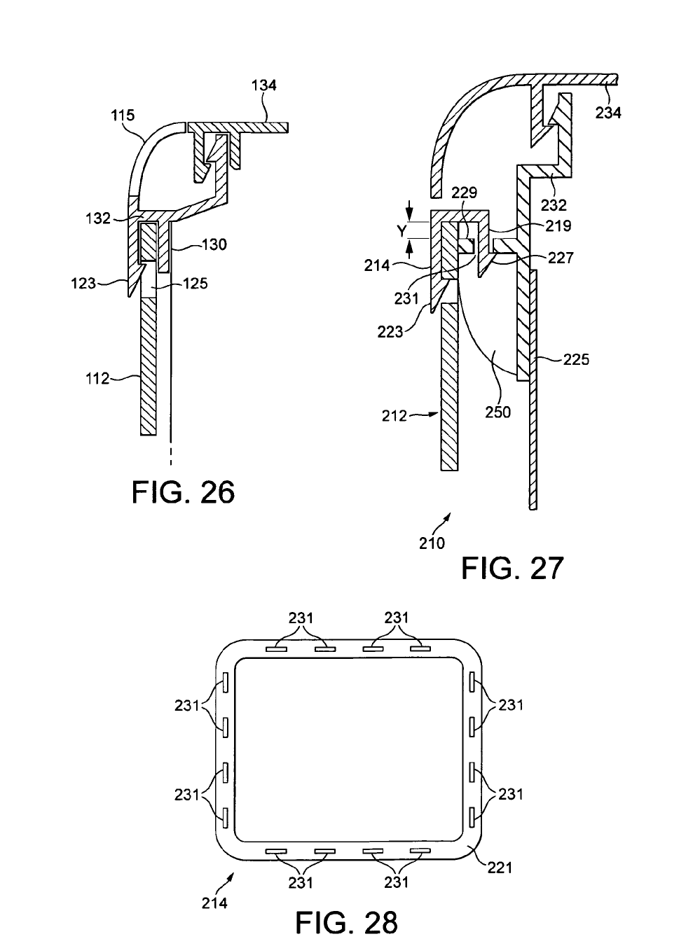

FIG. 26 is a sectional (B-B) view of the paint container of FIG. 23,

FIG. 27 is a sectional view of an alternative paint container, and

FIG. 28 is a plan view of part of the paint container of FIG. 27.

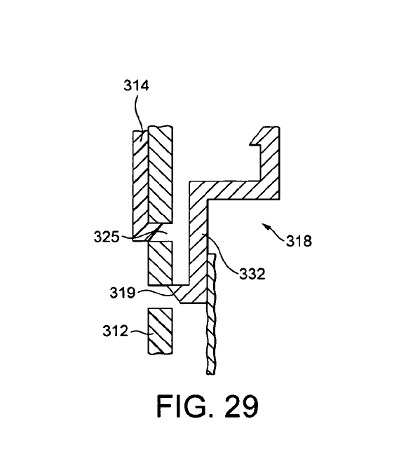

FIG. 29 is a side sectional view of an alternative paint container.

With reference to FIG. 1 there is a shown a paint container 10 comprising a main body 12, a plastic shroud 14, and a disposable liner assembly 18.

The plastic shroud 14 is attached to a handle 15. It can be seen from FIGS. 1 and 3 that the handle 15 is arranged such that (in the closed position—FIGS. 1 and 3), an outer periphery is defined by the handle 15 and the plastic shroud 14. The handle 15 is hingeable attached to the shroud 14 such that it can be moved between a resting position (FIG. 1) and a carrying position (FIG. 2).

The main body 12 is of rectangular construction comprising a front 20, rear 22, left 24, and right 26 side walls, and a base 28. The main body 12 is constructed of cardboard, (often referred to as paperboard) typically comprising multiple layers to increase rigidity. It is to be understood that the invention is not limited to cardboard only main bodies, and also includes composite structures which include a barrier layer, typically metallic. However, the advantage of using a main body constructed cardboard only is the easier ability to recycle and/or reuse.

The main body 12 has two through apertures 25 located in each of its four side walls (FIG. 2 where only two apertures on each of the left and front side walls are shown).

The shroud 14 is of rectangular construction corresponding to the main body 12, and includes four sides, left 41, front 43, right 45, and rear 47 (FIG. 1) which are defined by an outboard downwardly extending portion 17. The downwardly extending portion 17 has retaining tabs 23 located at its lowermost end, and a downwardly extending rib 19. In FIGS. 1, each of the four sides 41,43,44,45 has two retaining tabs.

The retaining tabs 23, and through apertures 25 are located such that there is snap fit engagement therebetween when the shroud 14 is assembled onto the main body 12 (see below).

In FIGS. 8 and 9, the liner assembly 18 comprises a plastic liner in the form of a bag 30, a plastic neck insert 32 and a lid 34.

The bag 30 has a closed end and an open end 33 so that it can receive and store liquid content such as paint.

The neck insert 32 is fixed (typically by welding although other joining techniques such as the use of adhesives are envisaged) to the bag 30 at is open end 33. The neck insert 32 has a similar rectangular plan profile when compared to the main body of the container (albeit slightly smaller such that the neck insert fits inside the main body), and has four sides corresponding to the main body such that that it can locate on the main body.

The bag 30 is both shaped and dimensioned such that it can utilise most if not substantially all of the volume inside the container when filled with paint.

The bag 30 includes a reinforcing ring 40, and a lower ring 90. The lower ring 90 optionally locates into notches 92 in the main body of the container.

The handle 15 locates inside aperture 60 of the shroud 14 and is retained on the shroud 14 by a snap-fit feature 70 (only shown in FIG. 9). It will be appreciated that when the container is being held by the handle 15, the weight is transferred to the shroud 14 and then to the main body 12 via retaining tabs 23.

The neck insert, shroud, handle, and lid are all plastic components, typically elastomers suitable for injection molding. A suitable plastic would be Polyethylene, be that high, medium or low density.

In an alternative embodiment, both the neck insert and the bag can be moulded from a single plastic component thereby negating the need for a joining process.

The container 10 is assembled as follows:

The liner assembly 18 is inserted into the main body 12 of the container 10 by lowering neck insert 14 in the direction of arrow Y (FIG. 11) until the shoulder 52 on the neck insert 14 abuts against top surface 54 of the main body 12 of the container 10 (FIG. 12). In FIG. 12, the liner assembly 18 is now positioned in the main body 12, but not yet securely retained in the vertical direction (arrow Y).

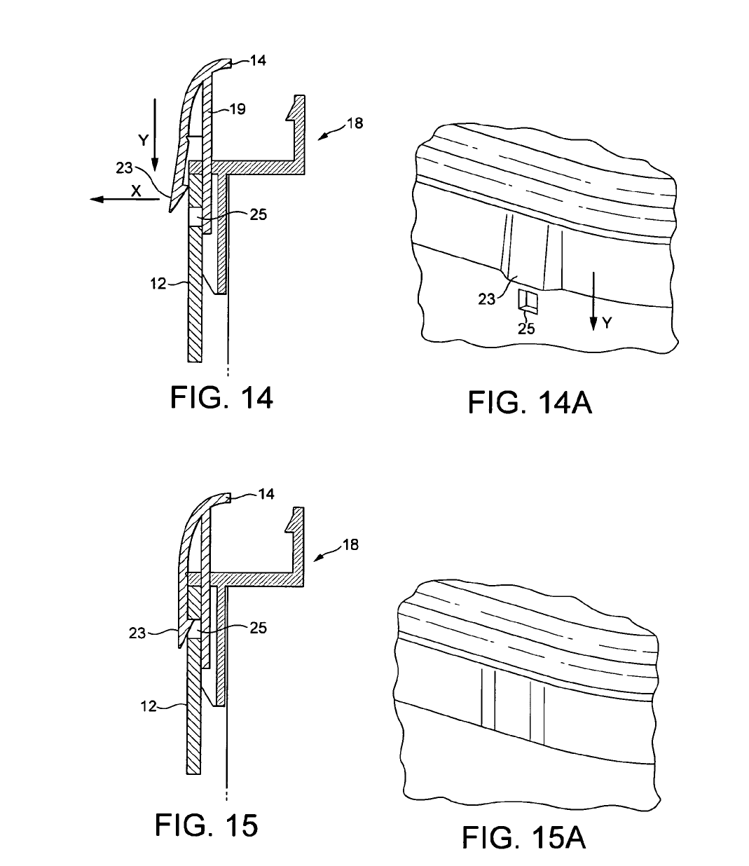

The shroud 14 is lowered in the direction of arrow Y (FIGS. 13 and 13A) such that the downwardly extending rib 19 passes through aperture 21 (only one shown. As the shroud 14 is lowered further, retaining tab 23 bulges outwards in the direction of arrow X (FIGS. 14 and 14A) by virtue of engagement with the main body 12 and the fact that the shroud material is sufficiently thin walled to flex, until the retaining tab 23 snap-fits into aperture 25 of the main body 14 (FIGS. 15 and 15A). It is to be understood that each of the eight retaining tabs (two on each of the four side walls of the shroud 14) snap-fit into each of the eight corresponding apertures 25 on the main body 12 to securely retained. As the shroud 14 is lowered onto the main body 12, ribs 50 of the neck insert compress the side walls of the main body between the shroud and the neck insert so as to provide an interference fit of the side walls between the shroud and the neck insert in addition to the snap-fit engagement between the shroud and the main body.

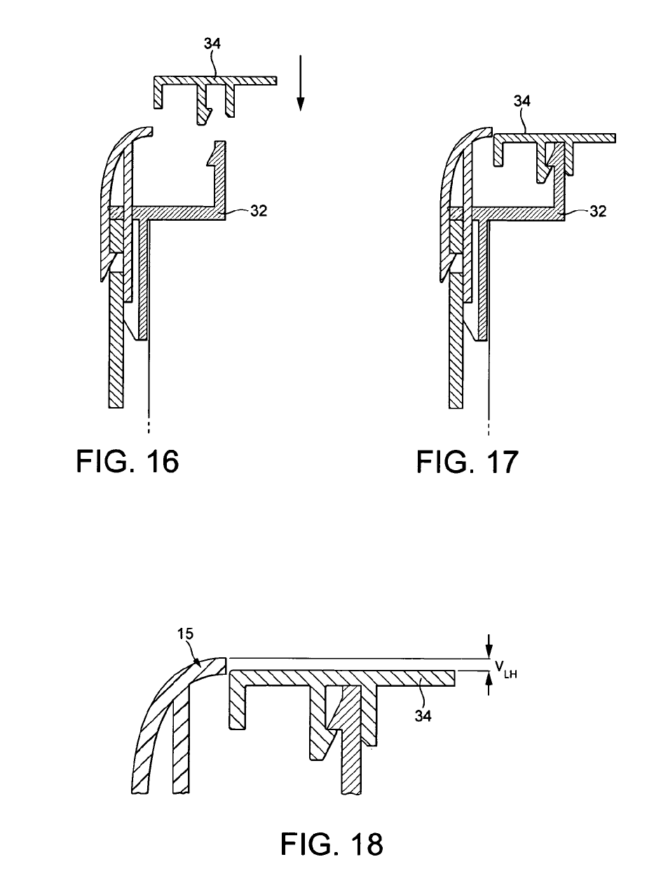

Lid 34 is secured onto liner assembly via snap-fit engagement with neck insert 32 (shown removed in FIG. 16, and secured in FIG. 17).

FIG. 18 shows in more detail that there is a vertical separation V_{LH} between the upper surface of the lid 34 and the upper surface of the handle 14, and specifically that the handle sits vertically above the lid 34. This is advantageous as this allows the weight of a similar second container stacked on top to be transmitted and born by the handle and not the lid. The stacked second container can have its base adapted in such a way to accommodate the protruding handle.

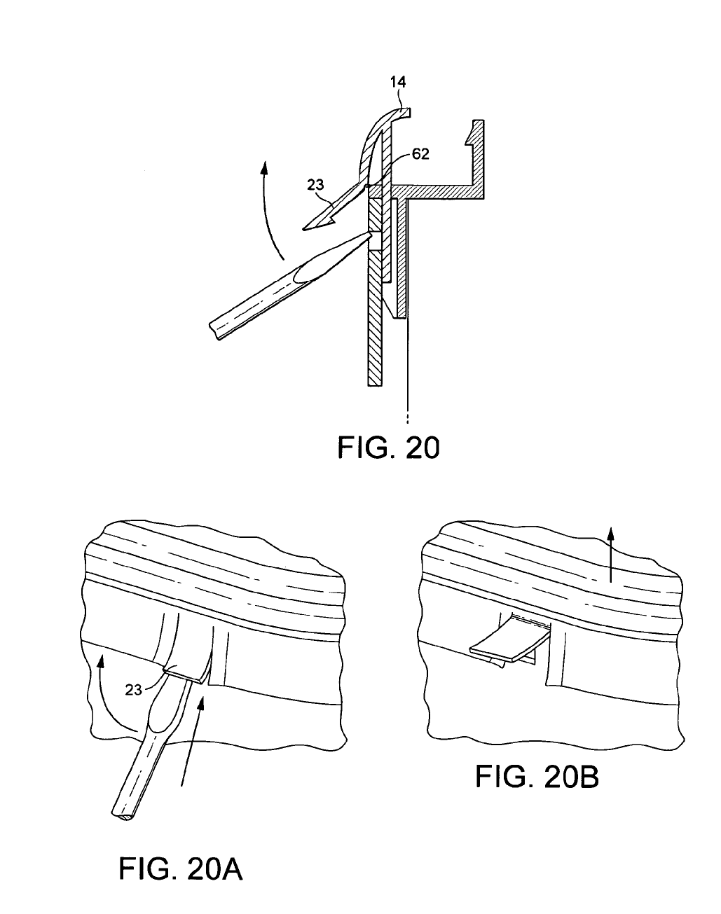

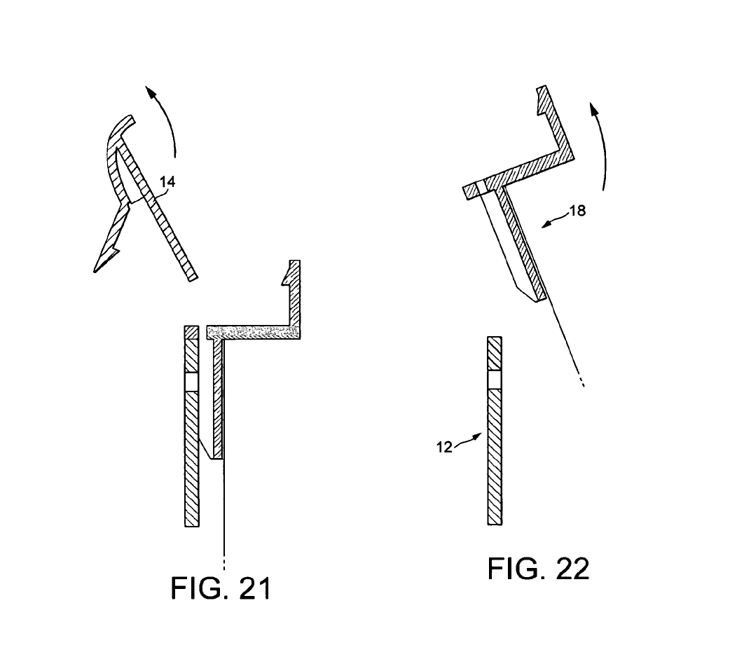

The shroud 14 is removed by inserting a tool such as a screwdriver 60 under tab 23 (FIGS. 19 and 19A) and prizing it away from the main body such that a weakened section 62 enables the tab 23 to break away from the main body (FIG. 20, 20A and 20B). The tab 23 is no longer biased towards the main body, and the shroud 14 can be lifted vertically such that it detaches itself from the main body (FIG. 21).

The liner assembly 18 can now be removed from the main body 14 since it is no longer retained by the shroud (FIG. 22).

The liner assembly 18 can be disposed of since it is contaminated with paint.

The plastic shroud 14 can be recycled easily as it is no longer attached to the liner assembly 18 or the cardboard main body 14.

The cardboard main body 14 can be recycled easily since it is no longer attached to the contaminated liner assembly 18 or the plastic shroud 14.

Thus, the present invention allows both the plastic shroud, and the cardboard body to be recycled, and easy disposal of the contaminated liner assembly. This compares to known containers where the liner assembly, plastic shroud, and neck insert cannot be separated, and therefore more plastic material has to be disposed of.

In the above embodiment, the shroud 14 is separated from the main body by releasing the snap-fit between the tab and the notch in the main body. In an alternative embodiment, the main body could include tear bands which are removed such that shroud 14 can be removed from the main body without the need to mechanically disengage the tab from the notch.

With reference to FIG. 23 there is shown an alternative container 110 comprising a main body 112 and a liner assembly 118.

The main body 112 is identical to main body 12 of the embodiment of FIGS. 1 to 22.

The liner assembly 118 comprises a bag 130 identical to the bag 30 of the embodiment of FIGS. 1 to 22, a plastic neck insert 132, and a lid 134.

The plastic neck insert and bag 130 are welded together.

The lid 132 secures to the plastic neck insert in the same way as in the embodiment of FIGS. 1 to 22.

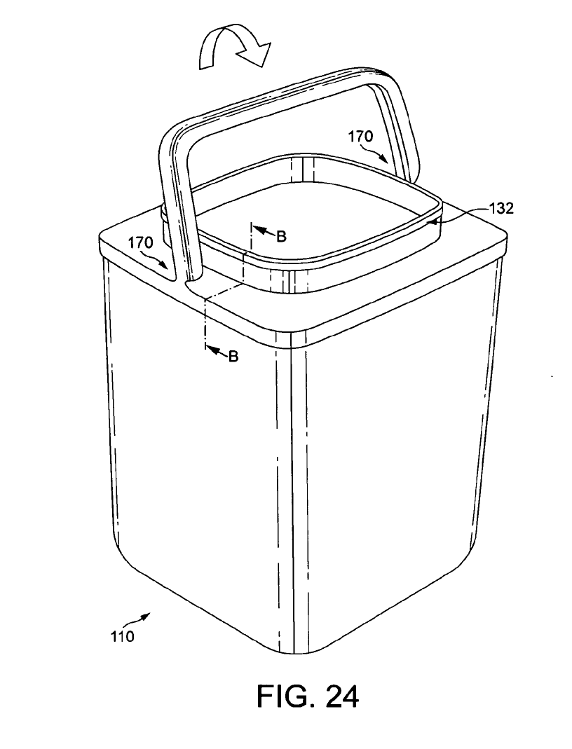

The plastic neck insert 132 includes an integral handle 115 which includes a live hinge 170 to enable it to move between the resting (FIG. 23) and carrying (FIG. 24) positions.

In contrast to the embodiment of FIGS. 1 to 22, the snap-fit tab 123 is incorporated on the neck insert 132 as opposed to the shroud, i.e. there is no separate shroud on container 110. Accordingly, the neck insert 132 and the bag 130 can be assembled onto and removed from main body 112 in the same way as in the embodiment of FIGS. 1 to 22 with the exception that no shroud is required to secure the neck insert (and hence the liner assembly) onto the main body.

As in the embodiment of FIGS. 1 to 22, the handle is arranged such that it vertically extends above the lid 134, thereby acting to carry the load of a second container stacked above.

With reference to FIGS. 27, there is shown an alternative paint container 210 which is identical to the container of FIGS. 1 to 22 apart from the modifications below.

In FIG. 27, the neck insert 232 includes a modified downwardly extending rib 219 having a retaining tab 227 at its lower end.

The neck insert 232 includes a substantially horizontally outwardly extending ledge 229 with apertures 231. Four apertures are positioned on each side of the neck insert (FIG. 28) so that they can engage with the corresponding retaining tabs 227.

The container 210 is assembled in the same way as the container of FIGS. 1 to 22 with the exception that downwardly extending rib 219 passes through aperture 231 on ledge 229 such that the retaining tab 227 snap-fits underneath the ledge 229 to retain the neck insert 218 inside the container 10. (FIG. 27). The vertical distance Y between the upper surface of the ledge 228 and the lower inside surface of the shroud 214 is shown exaggerated, whereas in practice this distance would be small, if not zero (subject to the manufacturing tolerances) so as to eliminate vertical movement upwardly, noting that the downward movement is prevented by the snap-fit engagement between tab 227 and the ledge.

Container 210 also includes a modified lid 234

In another embodiment, the neck insert 232 could engage, for example via a snap-fit feature, directly with the main body 312 of the paint container so as to secure the liner assembly to the paint container. The shroud 314 could then engage (via a snap-fit for example) with the main body as described in the previous embodiments via aperture 325.

Alternatively, the shroud could snap-fit onto the liner assembly by provision of a corresponding feature on the liner assembly (not shown), with no requirement for the shroud to snap-fit to the main body.

1. A paint container comprising a main body, a liner assembly which locates inside the main body, and a shroud, wherein the shroud cooperates with the liner assembly and the main body so as to releasably secure the liner assembly to the main body.

2. The paint container according to claim 1 wherein the shroud is releasably attachable to the main body.

3. The paint container according to claim 2 wherein the shroud directly engages with the main body via a snap-fit engagement.

4. The paint container according to claim 3, wherein the main body includes at least one aperture, the shroud includes at least one snap-fit feature, and the snap-fit engagement is between the at least one aperture and the at least one snap-fit feature.

5. The paint container according to claim 1 wherein the liner assembly is releasably attachable to the shroud.

6. The paint container according to claim 1 wherein the liner assembly is releasable attachable to the main body.

7. The paint container according to claim 6 wherein the liner assembly directly engages with the main body via a snap-fit engagement.

8. The paint container according to claim 1 wherein the liner assembly comprises a neck insert which is attached to a flexible bag.

9. The paint container according to claim 8 wherein the shroud engages with the neck insert.

10. The paint container according to claim 9 wherein the shroud engages with the neck insert via a snap-fit engagement.

11. The paint assembly according to claim 8 wherein the main body is sandwiched between the neck insert and the shroud so as to provide an interference fit.

12. A paint container comprising a main body, and a liner assembly, wherein the liner assembly includes a snap-fit feature which engages with a corresponding feature on the main body to releasably secure the liner assembly to the main body.

13. The paint container according to claim 12 wherein the corresponding feature on the main body is a through aperture.

14. The paint container according to claim 1 wherein the main body is made from cardboard.

15. The paint container according to claim 1, further comprising a handle, wherein the handle is attached to the shroud.

16. The paint container according to claim 1, further comprising a cover.

17. The paint container according to claim 16, wherein the cover engages with the liner assembly.

18. (canceled)

19. The paint container according to claim 4 wherein the liner assembly is releasably attachable to the shroud.

20. The paint container according to claim 8, further comprising a handle, wherein the handle is attached to the shroud.

21. The paint container according to claim 12 wherein the main body is made from cardboard.
